(19) United States
(12) Patent Application Publication
(10) Pub. No.: US 2022/0229378 A1
(43) Pub. Date: Jul. 21, 2022

(54) METHOD FOR PRODUCING LIQUID DEVELOPER

(71) Applicant: Kao Corporation, Tokyo (JP)

(72) Inventors: Nobuaki OKAUCHI, Wakayama-shi (JP); Akitaka MITSUJI, Wakayama-shi (JP)

(73) Assignee: Kao Corporation, Tokyo (JP)

(21) Appl. No.: 17/623,053

(22) PCT Filed: Apr. 14, 2020
(86) PCT No.: PCT/JP2020/016426

§ 371 Date: Dec. 27, 2021

(30) Foreign Application Priority Data
Jun. 28, 2019 (JP) 2019-121075

(51) Int. Cl. G03G 9/13

(52) U.S. Cl. CPC G03G 9/13

(57) ABSTRACT

A method for producing a liquid developer containing a resin binder, a colorant, and an insulating liquid, the resin binder containing a polyester resin A comprising a constituting unit derived from an alcohol component and a constituting unit derived from a carboxylic acid component containing an acid modified product A of an α-olefin polymer having 3 or more carbon atoms and 18 or less carbon atoms, including: step I: stirring raw materials containing the resin binder and the colorant or raw materials containing the resin binder, the colorant, and a part of the insulating liquid at a temperature of equal to or higher than a glass transition temperature of the resin binder; and step II: adding dropwise the insulating liquid to a stirred mixture of the step I in an amount to make a total of the amounts used in the step I and the step II of 50 parts by mass or more and 500 parts by mass or less, based on 100 parts by mass of a total amount of the resin binder and the colorant at a temperature of equal to or higher than a glass transition temperature of the resin binder, thereby carrying out a phase inversion emulsification, to provide a dispersion of toner particles. The liquid developer obtained by the method of the present invention is suitably used for development or the like of latent images formed in electrophotography, electrostatic recording method, electrostatic printing method or the like.

### FIELD OF THE INVENTION

The present invention relates to a method for producing a liquid developer usable in development of latent images formed in, for example, electrophotography, electrostatic recording method, electrostatic printing method or the like.

### BACKGROUND OF THE INVENTION

Electrophotographic developers are a dry developer in which toner components composed of materials containing a colorant and a resin binder are used in a dry state, and a liquid developer in which toner components are dispersed in an insulating liquid.

In a liquid developer, toner particles are dispersed in oil in an insulating liquid, thereby making it possible to form smaller particle sizes as compared to a dry developer. Therefore, high-quality printouts can be obtained surpassing offset printing, so that the liquid developer is suitable for applications in commercial printings. In addition, in the recent years, since the demands for speeding up have been increasing, liquid developers having smaller particle sizes of toner particles and reduced viscosities have been desired.

Patent Publication 1 discloses a method for producing a liquid developer utilizing a coacervation method, characterized in that the method includes dispersing colored resin particles in an insulating hydrocarbon-based dispersion medium in the presence of a particle dispersant, which is a reaction product of a polyamine compound and a hydroxycarboxylic acid self-condensate, and an acidic group-containing resin.

Patent Publication 2 discloses a method for producing a liquid developer including the steps of adding a colored resin to a nonpolar dispersion medium, heating the nonpolar dispersion medium to a temperature of equal to or higher than a softening point of the resin, stirring the nonpolar dispersion medium to which the resin is added and heated to form a resin emulsion, and cooling the resin emulsion to solidify colored fine resin particles.

Patent Publication 3 discloses a method for producing a liquid developer in which toner particles are dispersed in an insulating liquid, characterized in that the method includes a molten mixture dispersion preparation step of preparing a molten mixture dispersion in which the kneaded mixture in a molten state is finely dispersed in the insulating liquid using a kneaded mixture containing a colorant and resin materials, and a cooling step of cooling the molten mixture dispersion to solidify the kneaded mixture in a molten state, wherein the insulating liquid is mainly composed of a non-volatile hydrocarbon.
Patent Publication 1: WO 2009/041634
Patent Publication 2: Japanese Patent Laid-Open No. Hei-09-179354
Patent Publication 3: Japanese Patent Laid-Open No. 2006-251253

### SUMMARY OF THE INVENTION

The present invention relates to:

[1] a method for producing a liquid developer containing a resin binder, a colorant, and an insulating liquid,
the resin binder containing a polyester resin A comprising a constituting unit derived from an alcohol component and a constituting unit derived from a carboxylic acid component containing an acid modified product A of an α-olefin polymer having 3 or more carbon atoms and 18 or less carbon atoms, including:
step I: stirring raw materials containing the resin binder and the colorant or raw materials containing the resin binder, the colorant, and a part of the insulating liquid at a temperature of equal to or higher than a glass transition temperature of the resin binder; and
step II: adding dropwise the insulating liquid to a stirred mixture of the step I in an amount to make a total of the amounts used in the step I and the step H of 50 parts by mass or more and 500 parts by mass or less, based on 100 parts by mass of a total amount of the resin binder and the colorant, at a temperature of equal to or higher than a glass transition temperature of the resin binder, thereby carrying out a phase inversion emulsification, to provide a dispersion of toner particles;
[2] a method for producing a liquid developer containing a resin binder, a colorant, and an insulating liquid,
the resin binder containing a polyester resin A that is a polycondensate of an alcohol component and a carboxylic acid component containing an acid modified product A of an α-olefin polymer having 3 or more carbon atoms and 18 or less carbon atoms, including:
step I: stirring raw materials containing the resin binder and the colorant or raw materials containing the resin binder, the colorant, and a part of the insulating liquid at a temperature of equal to or higher than a glass transition temperature of the resin binder; and
step II: adding dropwise the insulating liquid to a stirred mixture of the step I in an amount to make a total of the amounts used in the step I and the step II of 50 parts by mass or more and 500 parts by mass or less, based on 100 parts by mass of a total amount of the resin binder and the colorant, at a temperature of equal to or higher than a glass transition temperature of the resin binder, thereby carrying out a phase inversion emulsification, to provide a dispersion of toner particles; and
[3] a method for producing a liquid developer containing a resin binder, a colorant, and an insulating liquid,
the resin binder containing a polyester resin A that is a polycondensate of a polycondensate of an alcohol component and a carboxylic acid component other than an acid modified product A of an α-olefin polymer having 3 or more carbon atoms and 18 or less carbon atoms, with the acid modified product A, including:
step I: stirring raw materials containing the resin binder and the colorant or raw materials containing the resin binder, the colorant, and a part of the insulating liquid at a temperature of equal to or higher than a glass transition temperature of the resin binder; and
step II: adding dropwise the insulating liquid to a stirred mixture of the step I in an amount to make a total of the amounts used in the step I and the step II of 50 parts by mass or more and 500 parts by mass or less, based on 100 parts by mass of a total amount of the resin binder and the colorant, at a temperature of equal to or higher than a glass transition temperature of the resin binder, thereby carrying out a phase inversion emulsification, to provide a dispersion of toner particles.

### DETAILED DESCRIPTION OF THE INVENTION

In the method for producing a liquid developer in which toner particles are formed according to a coacervation method as in Patent Publication 1, the formation of smaller particles of the toner particles is not sufficient. In addition, in the methods for producing a liquid developer in which toner particles are formed according to a forced emulsification by a mechanical stirring force as in Patent Publications 2 and 3, costs increase in the implement of the agitation apparatus.

The present invention relates to a method capable of conveniently producing a liquid developer having smaller particle sizes of toner particles and reduced viscosity without using specialized instruments or organic solvents.

According to the method of the present invention, a liquid developer having smaller particle sizes of toner particles and reduced viscosity can be conveniently produced without using specialized instruments or organic solvents.

The present invention is a method for producing a liquid developer containing a resin binder containing a polyester resin A using an acid modified product A of an α-olefin polymer having 3 or more carbon atoms and 18 or less carbon atoms, a colorant, and an insulating liquid according to steps I and II described later. Since the polyester resin A is a self-dispersible resin, the toner particles can be dispersed in an insulating liquid in the phase inversion emulsification of the step II without substantially using a dispersant, and according to the method of the present invention, a liquid developer having smaller particle sizes of toner particles and reduced viscosity can be conveniently produced without using specialized instruments or organic solvents. Here, in the step II, the phrase “without substantially using a dispersant” means that a liquid developer is produced in which the content of the dispersant is 0.5% by mass or less, preferably 0.3% by mass or less, more preferably 0.1% by mass or less, even more preferably 0.05% by mass or less, even more preferably less than 0.01% by mass, and even more preferably 0% by mass. The dispersant is not particularly limited, so long as the dispersant is ordinarily used as a dispersant for a liquid developer. Examples include polyamine-based resin dispersants (SOLSPARSE 24000SC, SOLSPARSE 32000 (hereinabove manufactured by Lubrizol Corporation), AJISPER PB821 (manufactured by Ajinomoto Fine-Techno Co., Inc.), and the like), resin dispersants of acrylic copolymers (BYK-116 (manufactured by BYK Chemie), and the like), and the like.

The step I is a step of stirring raw materials containing the resin binder containing the polyester resin A and the colorant, or raw materials containing the resin binder, the colorant and a part of the insulating liquid at a temperature of equal to or higher than a glass transition temperature of the resin binder.

The polyester resin A comprises a constituting unit derived from an alcohol component, preferably an alcohol component containing an alkylene oxide adduct of bisphenol A and/or a constituting unit derived from an alcohol component containing an aliphatic diol having 2 or more carbon atoms and 6 or less carbon atoms, and a constituting unit derived from a carboxylic acid component containing an acid modified product A of an α-olefin polymer having 3 or more carbon atoms and 18 or less carbon atoms. It is preferable that the polyester resin A comprises a structure in which the constituting unit derived from an alcohol component, preferably an alcohol component containing an alkylene oxide adduct of bisphenol A and/or a constituting unit derived from an alcohol component containing 80% by mol or more of an aliphatic diol having 2 or more carbon atoms and 6 or less carbon atoms, and the constituting unit derived from an acid modified product A of an α-olefin polymer having 3 or more carbon atoms and 18 or less carbon atoms are connected with an ester bond.

It is preferable that the alcohol component contains an alkylene oxide adduct of bisphenol A and/or an aliphatic diol having 2 or more carbon atoms and 6 or less carbon atoms, from the viewpoint of the low-temperature fusing ability and the reactivities with the acid modified product A.

It is preferable that the alkylene oxide adduct of bisphenol A contained in the alcohol component is a compound represented by the formula (I):

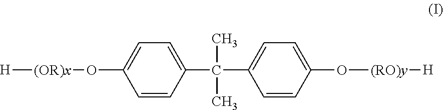

wherein OR and RO are an oxyalkylene group, wherein R is an ethylene group and/or a propylene group; and each of x and y is a positive number showing an average number of moles of alkylene oxide added, wherein a value of the sum of x and y is 1 or more, and preferably 1.5 or more, and 16 or less, preferably 8 or less, more preferably 6 or less, and even more preferably 4 or less.

The alkylene oxide adduct of bisphenol A represented by the formula (I) includes polyoxypropylene adducts of 2,2-bis(4-hydroxyphenyl)propane, polyoxyethylene adducts of 2,2-bis(4-hydroxyphenyl)propane, and the like. These alkylene oxide adducts can be preferably used alone or in two or more kinds.

The content of the alkylene oxide adduct of bisphenol A represented by the formula (I) in the alcohol component is preferably 70% by mol or more, more preferably 80% by mol or more, even more preferably 90% by mol or more, even more preferably 95% by mol or more, and even more preferably 100% by mol. Here, the content of the compound contained in the alcohol component or the carboxylic acid component as used herein is the same as the proportion of the constituting units derived from the compound in the polyester resin.

In addition, the aliphatic diol having 2 or more carbon atoms and 6 or less carbon atoms contained in the alcohol component includes, for example, ethylene glycol, 1,2-propanediol, 1,3-propanediol, 1,4-butanediol, 1,5-pentanediol, neopentyl glycol, 1,6-hexanediol, and the like. Among them, one or more members selected from the group consisting of ethylene glycol, 1,2-propylene glycol, and neopentyl glycol are preferred, and a combination of ethylene glycol and neopentyl glycol is more preferred. The molar ratio of ethylene glycol to neopentyl glycol (ethylene glycol/neopentyl glycol) is preferably 15/85 or more, and more preferably 20/80 or more, and preferably 60/40 or less, and more preferably 50/50 or less.

The content of the aliphatic diol having 2 or more carbon atoms and 6 or less carbon atoms in the alcohol component is preferably 80% by mol or more, more preferably 90% by mol or more, even more preferably 95% by mol or more, and even more preferably 100% by mol.

Other alcohol components include trihydric or higher polyhydric alcohols such as glycerol, and the like.

In the acid modified product A of the α-olefin polymer having 3 or more carbon atoms and 18 or less carbon atoms contained in the carboxylic acid component, the number of carbon atoms of the α-olefin is 3 or more, and preferably 4 or more, and 18 or less, preferably 10 or less, more preferably 7 or less, even more preferably 5 or less, and even more preferably 4 or less. The number of carbon atoms is particularly preferably 4, from the viewpoint of further lowered viscosity.

The α-olefin polymer having 3 or more carbon atoms and 18 or less carbon atoms includes polypropylene-based polymers, polyisobutene-based polymers, poly 1-butene-based polymers, poly 1-pentene-based polymers, poly 1-hexene-based polymers, poly 1-octene-based polymers, poly 4-methylpentene-based polymers, poly 1-dodecene-based polymers, poly 1-hexadecene-based polymers, propylene-hexene copolymers, and the like, and among them, the polyisobutene-based polymers are preferred. The above α-olefin polymer may be a homopolymer of the above α-olefin, or may be a copolymer of two or more members selected from the above α-olefins, or may be a copolymer of the above α-olefin with another olefin. In addition, the copolymer may be any one of random copolymers and block copolymers.

The polyisobutene-based polymer includes polyisobutenes and copolymers of isobutene and other olefins. The other olefins include, for example, ethylene, butene, pentene, hexene, and 2-ethylhexene. When the polyisobutene-based polymer is a copolymer, the proportion of isobutene is preferably 60% by mass or more, more preferably 80% by mass or more, and even more preferably 90% by mass or more, and less than 100% by mass.

On the other hand, the acid modified product A is preferably an acid modified product in which an α-olefin polymer having 3 or more carbon atoms and 18 or less carbon atoms is modified with at least one acid selected from the group consisting of maleic acid, fumaric acid, itaconic acid, and acid anhydrides thereof, and more preferably an acid modified product modified with maleic anhydride, from the viewpoint of the reactivities with the polyester resin. In addition, the acid modified product includes an acid modified product in a random graft form in which the above α-olefin polymer is randomly grafted and modified with an acid, an acid modified product in an end modification form in which an end of the above α-olefin polymer is modified with an acid, and the like. In the present invention, the acid modified product in an end modification form is preferred, and an acid modified product in a one-end modification form in which one end of the α-olefin polymer having 3 or more carbon atoms and 18 or less carbon atoms is modified with an acid is more preferred, from the viewpoint of low-temperature fusing ability and storage property.

The acid modified product in a random graft form is preferably such that one molecule of the polymer is grafted with one or more acids and modified. Whether or not the polymer is modified with an acid can be defined by a general spectroscopic measurement. For example, in a case of an acid modified product in a random graft form with maleic anhydride, when the polymer is modified with maleic anhydride, a double bond of maleic anhydride is changed to a single bond, so that the modification can be defined by the measurement of a spectroscopic change thereof.

The acid modified product in a random graft modification form is obtained by, for example, generating a radical within a molecule of an α-olefin polymer, and reacting the radical with a carboxylic acid compound or an anhydride thereof having an unsaturated bond.

The acid modified product in an end modification form is preferably one in which one molecule of the polymer is modified with one acid (one-end) or two acids (both-ends). Whether or not the polymer is modified with an acid can be defined by a general spectroscopic measurement. For example, in a case of an acid modified product in a one-end modification form with maleic anhydride, when the polymer is modified with maleic anhydride, a double bond of maleic anhydride is changed to a single bond, so that the modification can be defined by the measurement of a spectroscopic change thereof. In addition, since a spectroscopic change takes place just before or after binding at the connected portion at a side of the α-olefin polymer, this modification can be defined by the measurement of the change.

The acid modified product in a one-end form is obtained, for example, by subjecting the above α-olefin polymer having an unsaturated bond at one end to an Ene reaction with an acid. The above α-olefin polymer having an unsaturated bond at one end is obtained by a known method, and the polymer can be produced by using, for example, a vanadium-based catalyst, a titanium-based catalyst, a zirconium-based catalyst or the like.

As described above, it is preferable that the acid modified product A of the α-olefin polymer is a polyisobutene succinic anhydride modified with maleic anhydride at one end.

It is preferable that the acid modified product A is amorphous. The amorphous acid modified product of an α-olefin polymer has even more improved hygroscopic resistance of the polyester resin, as compared to a crystalline acid modified product of an α-olefin polymer such as a modified polypropylene-based polymer having a carboxylate group or a carboxylate anhydride group. This is assumed to be due to the fact that the amorphous acid modified product of the α-olefin polymer does not have a melting point, so that the acid modified product is allowed to spread in a wet state on the toner surfaces even when a hydrophobic polyolefin moiety is at a low temperature. Here, the crystallinity of the acid modified product is expressed by a crystallinity index ([softening point/highest temperature of endothermic peak]) in the same manner as the crystallinity of the resins described later. The amorphous acid modified product has a crystallinity index of exceeding 1.4, preferably exceeding 1.5, and more preferably 1.6 or more, or less than 0.6, and preferably 0.5 or less. In addition, those in which a highest temperature of endothermic peak is not detectable are judged to be amorphous.

The weight-average molecular weight of the acid modified product A is preferably 500 or more, more preferably 700 or more, even more preferably 900 or more, and even more preferably 1,100 or more, from the viewpoint of storage property, and the weight-average molecular weight is preferably 5,000 or less, more preferably 4,000 or less, and even more preferably 3,000, from the viewpoint of low-temperature fusing ability.

The content of the acid modified product A, based on 100 parts by mass of a total amount of the alcohol component and the carboxylic acid component other than the acid modified product A, is preferably 3 parts by mass or more, more preferably 4 parts by mass or more, even more preferably 7 parts by mass or more, even more preferably 9 parts by mass or more, even more preferably 10 parts by mass or more, even more preferably 15 parts by mass or more, and even more preferably 20 parts by mass or more, from the viewpoint of the initial rise in charging and hygroscopicity, and the content is preferably 40 parts by mass or less, more preferably 30 parts by mass or less, and even more preferably 25 parts by mass or less, from the viewpoint of storage property.

The carboxylic acid component other than the acid modified product A of the above α-olefin polymer is preferably at least one member selected from the group consisting of aromatic dicarboxylic acid compounds, aliphatic dicarboxylic acid compounds, and tricarboxylic or higher polycarboxylic acid compounds. It is more preferable that the carboxylic acid component contains an aromatic dicarboxylic acid compound, from the viewpoint of durability.

The aromatic dicarboxylic acid compound includes phthalic acid, isophthalic acid, terephthalic acid, anhydrides and alkyl esters of these acids, the alkyl group having from 1 to 3 carbon atoms, and the like. Among them, terephthalic acid or isophthalic acid is preferred, and terephthalic acid is more preferred, from the viewpoint of low-temperature fusing ability.

The content of the aromatic dicarboxylic acid compound in the carboxylic acid component other than the acid modified product A of the α-olefin polymer is preferably 80% by mol or more, more preferably 90% by mol or more, and even more preferably 95% by mol or more, from the viewpoint of storage property.

The aliphatic dicarboxylic acid compound includes aliphatic dicarboxylic acids such as oxalic acid, malonic acid, maleic acid, fumaric acid, citraconic acid, itaconic acid, glutaconic acid, succinic acid which may be substituted with an alkyl group having from 1 to 20 carbon atoms or an alkenyl group having from 2 to 20 carbon atoms, and adipic acid, and anhydrides and alkyl esters of these acids, the alkyl group having from 1 to 3 carbon atoms, and it is preferable that succinic acid which is substituted with an alkyl group having from 1 to 20 carbon atoms or an alkenyl group having from 2 to 20 carbon atoms is contained. The succinic acid is preferably succinic acid which is substituted with an alkyl group or alkenyl group having from 6 to 14 carbon atoms, and more preferably succinic acid which is substituted with an alkyl group or alkenyl group having from 8 to 12 carbon atoms. Specific examples include octylsuccinic acid, dodecenylsuccinic acid (tetrapropenylsuccinic acid), and the like.

The tricarboxylic or higher polycarboxylic acid compound includes 1,2,4-benzenetricarboxylic acid (trimellitic acid), 2,5,7-naphthalenetricarboxylic acid, pyromellitic acid, and anhydrides and alkyl esters of these acids, the alkyl group having from 1 to 3 carbon atoms, among which the trimellitic acid compounds are preferred.

In the present invention, it is preferable that the polyester resin A is a linear polyester resin, from the viewpoint of low-temperature fusing ability and storage property. Therefore, it is preferable that the polyester resin A does not substantially contain trivalent or higher polyvalent raw material monomers (trihydric or higher polyhydric alcohols and tricarboxylic or higher polycarboxylic acid compounds) that have a crosslinking action. Here, the phrase “does not substantially contain trivalent or higher polyvalent raw material monomers” refers to the matter that even when contained, the content in a total amount of the alcohol component and the carboxylic acid component is preferably 5% by mol or less, more preferably 3% by mol or less, even more preferably 1% by mol or less, and even more preferably 0% by mol.

Here, polyethylene terephthalate (PET) may be used together with the alcohol component and the carboxylic acid component. PET or ethylene glycol and terephthalic acid formed by a partial depolymerization thereof as raw material monomers are subjected to a polycondensation reaction to incorporate the monomers into the polyester resin. PET is an equimolar polycondensate of ethylene glycol and terephthalic acid, in which ethylene glycol and terephthalic acid constituting the PET are regarded as an alcohol component and a carboxylic acid component, respectively.

The alcohol component may properly contain a monohydric alcohol, and the carboxylic acid component may properly contain a monocarboxylic acid compound.

The polyester resin A can be produced, for example, by polycondensing the alcohol component and the carboxylic acid component in an inert gas atmosphere at a temperature of preferably 130° C. or higher, and more preferably 170° C. or higher, and preferably 250° C. or lower, and more preferably 240° C. or lower, preferably in the presence of an esterification catalyst, further optionally in the presence of an esterification promoter, a polymerization inhibitor or the like.

The esterification catalyst includes tin compounds such as dibutyltin oxide and tin(II) 2-ethylhexanoate; titanium compounds such as titanium diisopropylate bistriethanolaminate; and the like. The amount of the esterification catalyst used is preferably 0.01 parts by mass or more, and more preferably 0.1 parts by mass or more, and preferably 1.5 parts by mass or less, and more preferably 1 part by mass or less, based on 100 parts by mass of a total amount of the alcohol component and the carboxylic acid component other than the acid modified product A. The esterification promoter includes gallic acid, and the like. The amount of the esterification promoter used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component other than the acid modified product A. The polymerization inhibitor includes t-butyl catechol, and the like. The amount of the polymerization inhibitor used is preferably 0.001 parts by mass or more, and more preferably 0.01 parts by mass or more, and preferably 0.5 parts by mass or less, and more preferably 0.1 parts by mass or less, based on 100 parts by mass of a total amount of the alcohol component and the carboxylic acid component other than the acid modified product A.

The polyester resin A may be a polycondensate of an alcohol component, preferably an alcohol component containing an alkylene oxide adduct of bisphenol A and/or an alcohol component containing an aliphatic diol having 2 or more carbon atoms and 6 or less carbon atoms and a carboxylic acid component containing an acid modified product A of an α-olefin polymer having 3 or more carbon atoms and 18 or less carbon atoms, or may be a polycondensate of a polycondensate of an alcohol component, preferably an alcohol component containing an alkylene oxide adduct of bisphenol A or an alcohol component containing an aliphatic diol having 2 or more carbon atoms and 6 or less carbon atoms and a carboxylic acid component other than an acid modified product A of an α-olefin polymer having 3 or more carbon atoms and 18 or less carbon atoms, with the acid modified product A. The latter polycondensate is preferred, from the viewpoint of storage property.

Here, in the present invention, the polyester resin A may be a polyester resin modified with a material other than an acid to an extent that the properties thereof are not substantially impaired. The polyester resin modified with a material other than an acid includes, for example, a polyester resin grafted or blocked with a phenol, a urethane, an epoxy or the like according to a method described in Japanese Patent Laid-Open No. Hei-11-133668, Hei-10-239903, Hei-8-20636, or the like. Among the modified polyester resins, urethane-modified polyester resins in which polyester resins are urethane-extended with a polyisocyanate compound are preferred.

The softening point of the polyester resin A is preferably 80° C. or higher, more preferably 90° C. or higher, and even more preferably 100° C. or higher, from the viewpoint of storage stability, and the softening point is preferably 150° C. or lower, more preferably 140° C. or lower, even more preferably 120° C. or lower, and even more preferably 110° C. or lower, from the viewpoint of low-temperature fusing ability.

It is preferable that the polyester resin A is an amorphous resin. Since the polyester resin is compatibilized and plasticized during melting of the acid modified product A by combining the amorphous polyester resin with the amorphous acid modified product A, the low-temperature fusing ability is even more improved.

The crystallinity of the resin is expressed by a crystallinity index, which is defined by a ratio of a softening point to a highest temperature of endothermic peak as determined by a differential scanning calorimeter, i.e. a value of [softening point/highest temperature of endothermic peak]. The crystalline resin is a resin having a crystallinity index of 0.6 or more, preferably 0.7 or more, and more preferably 0.9 or more, and 1.4 or less, preferably 1.2 or less, and more preferably 1.1 or less, and on the other hand, the amorphous resin is a resin having a crystallinity index exceeding 1.4, and preferably exceeding 1.5, and more preferably 1.6 or more, or a resin having a crystallinity index of less than 0.6, and preferably 0.5 or less. The crystallinity of the resin can be adjusted in accordance with the kinds and the ratios of the raw material monomers, and the production conditions (for example, reaction temperatures, reaction time, cooling rate) or the like. Here, a highest temperature of endothermic peak refers to a temperature of the peak at the highest temperature side out of the observed endothermic peaks. In a crystalline resin, a highest temperature of endothermic peak is defined as a melting point.

The glass transition temperature of the polyester resin A is preferably 40° C. or higher, and more preferably 50° C. or higher, from the viewpoint of storage stability, and the glass transition temperature is preferably 80° C. or lower, more preferably 70° C. or lower, even more preferably 65° C. or lower, even more preferably 60° C. or lower, and even more preferably 55° C. or lower, from the viewpoint of low-temperature fusing ability.

The acid value of the polyester resin A is preferably 0.5 mgKOH/g or more, and more preferably 1.5 mgKOH/g or more, from the viewpoint of low-temperature fusing ability, and the acid value is preferably 15 mgKOH/g or less, more preferably 10 mgKOH/g or less, and even more preferably 5 mgKOH/g or less, from the viewpoint of hygroscopic resistance.

The resin binder composition of the present invention may contain a polyester resin other than the polyester resin A, a vinyl-based resin such as a styrene-acrylic resin, an epoxy resin, a polycarbonate, a polyurethane, a composite resin containing two or more kinds of these resins, and the like. The content of the polyester resin A in the resin binder composition is preferably 80% by mass or more, more preferably 90% by mass or more, even more preferably 95% by mass or more, and even more preferably 100% by mass.

The content of the resin binder composition of the present invention in the liquid developer is preferably 15% by mass or more, more preferably 20% by mass or more, and even more preferably 25% by mass or more, and preferably less than 50% by mass, more preferably 45% by mass or less, and even more preferably 40% by mass or less.

As the colorant, dyes, pigments, and the like which are used as colorants for toners can be used. Examples include carbon blacks, Phthalocyanine Blue, Permanent Brown FG, Brilliant Fast Scarlet, Pigment Green B, Rhodamine-B Base, Solvent Red 49, Solvent Red 146, Solvent Blue 35, quinacridone, carmine 6B, isoindoline, disazo yellow, and the like. In the present invention, the toner particles may be any one of black toners and color toners.

The amount of the colorant used in the step I is preferably 1 part by mass or more, more preferably 3 parts by mass or more, and even more preferably 5 parts by mass or more, based on 100 parts by mass of the resin binder, from the viewpoint of improving optical density, and the amount used is preferably 100 parts by mass or less, more preferably 70 parts by mass or less, even more preferably 50 parts by mass or less, even more preferably 25 parts by mass or less, even more preferably 20 parts by mass or less, even more preferably 15 parts by mass or less, and even more preferably 10 parts by mass or less, based on 100 parts by mass of the resin binder, from the viewpoint of improving pulverizability of the toner, thereby forming smaller particle sizes, from the viewpoint of improving low-temperature fusing ability, and from the viewpoint of improving dispersion stability of the toner particles, thereby improving storage stability.

The insulating liquid used in the step I may be identical to or different from an insulating liquid used in the step II.

The amount of the insulating liquid used in the step I, based on 100 parts by mass of a total amount of the resin binder and the colorant, is preferably 1 part by mass or more, more preferably 5 parts by mass or more, even more preferably 10 parts by mass or more, and even more preferably 15 parts by mass or more, from the viewpoint of miscibility of the toner raw materials, and the amount used is preferably 100 parts by mass or less, more preferably 80 parts by mass or less, even more preferably 50 parts by mass or less, and even more preferably 35 parts by mass or less, from the viewpoint of formation of phase inversion emulsification of the toner.

The content of the resin binder in the stirred mixture in the step I is preferably 50% by mass or more, more preferably 60% by mass or more, and even more preferably 70% by mass or more, from the viewpoint of formation of phase inversion emulsification of the toner, and the content is preferably 99% by mass or less, more preferably 95% by mass or less, even more preferably 90% by mass or less, and even more preferably 80% by mass or less, from the viewpoint of miscibility of the toner raw materials.

The stirring temperature in the step I is a temperature equal to or higher than a glass temperature Tg of the resin binder, preferably equal to or higher than a temperature calculated as Tg plus 10° C. (+10° C.), more preferably equal to or higher than a temperature calculated as Tg+20° C., even more preferably equal to or higher than a temperature calculated as Tg+30° C., even more preferably equal to or higher than a temperature calculated as Tg+40° C., and even more preferably equal to or higher than a temperature calculated as Tg+50° C., from the viewpoint of miscibility of the toner raw materials, and the stirring temperature is preferably equal to or lower than a temperature calculated as Tg plus 150° C. (+150° C.), more preferably equal to or lower than a temperature calculated as Tg+125° C., even more preferably equal to or lower than a temperature calculated as Tg+100° C., even more preferably equal to or lower than a temperature calculated as Tg+80° C., and even more preferably equal to or lower than a temperature calculated as Tg+70° C., from the viewpoint of miscibility of the toner raw materials. In the present invention, when the resin binder is composed of plural resins, a weighted average of glass transition temperatures of each of the resins is defined as a glass transition temperature of the resin binder.

The stirring time in the step I is not particularly limited so long as the toner raw materials are stirred to an extent of being homogenously mixed, and the stirring time is preferably 0.5 minutes or more, more preferably 5 minutes or more, and even more preferably 20 minutes or more, and preferably 180 minutes or less, more preferably 150 minutes or less, even more preferably 120 minutes or less, even more preferably 60 minutes or less, and even more preferably 40 minutes or less.

The stirring means and the stirring rate are not particularly limited so long as the method allows to stir the entire raw materials. Among them, in the step I, it is preferable that the stirring is carried out with a mixer in which an axis of revolution is connected with two or more axes of rotations, and agitation blades arranged on each of the axes of rotation perform planetary movements (hereinafter referred to as a planetary mixer), a paddle-shaped agitator, a kneader-type mixer, or the like, and more preferably a planetary agitator, from the viewpoint of dispersibility of the colorant and formation of smaller particle sizes of the toners.

Specifically, in the step I, since the mixing (or kneading) is carried out in a state that a solid content concentration is high, the viscosities of the mixture (or the kneaded mixture) vary in a wide range depending upon the state of mixing (or kneading). Since the mixture is in a highly viscous state, especially in the step I, the stirring may be insufficient or uneven in some cases. As a result, dispersion and phase inversion emulsification of the colorant may not be sufficiently carried out in some cases. From the above viewpoint, as a mixer, those mentioned above are preferably used, and a planetary mixer is preferred, from the viewpoint of meeting a wide range of viscosities from low to high.

The planetary mixer allows to stir and mix (or knead) a mixture in an agitation vessel using agitation blades each having two axes of rotations and revolution, and the planetary mixer has a structure in which a dead space in the agitation vessel can be reduced, whereby homogeneous mixing (or kneading) can be obtained. In addition, a high load can be applied by having a shape of the blades that is thick. Further, the mixing (or the kneading) can be performed in a wide range from high load to low load, and all the states of from those having high viscosities to low viscosities during mixing can be performed in the same agitation vessel.

The planetary mixer which can be used in the present invention is the same as those described in Japanese Patent Laid-Open No. 2018-106145.

The step II is a step of adding dropwise the insulating liquid to a stirred mixture of the step I in an amount to make a total of the amounts used in the step I and the step II of 50 parts by mass or more and 500 parts by mass or less, based on 100 parts by mass of a total amount of the resin binder and the colorant, at a temperature of equal to or higher than a glass transition temperature of the resin binder, thereby carrying out a phase inversion emulsification, to provide a dispersion of toner particles. In the present invention, the phase inversion emulsification refers a state that the raw materials of toner particles which have been originally in a continuous phase are dispersed as toner particles in a dispersion medium in which an insulating liquid is a continuous phase. It is preferable that the step II is also carried out under stirring in the same manner as in the step I.

The insulating liquid in the present invention means a liquid through which electricity is less likely to flow, and in the present invention, the conductivity of the insulating liquid is preferably 1.0×10⁻¹¹ S/m or less, and more preferably 5.0×10⁻¹² S/m or less, and preferably 1.0×10⁻¹⁴ S/m or more.

Specific examples of the insulating liquid include, for example, aliphatic hydrocarbons, alicyclic hydrocarbons, aromatic hydrocarbons, halogenated hydrocarbons, polysiloxanes, vegetable oils, and the like. In particular, the aliphatic hydrocarbons such as liquid paraffin and isoparaffin are preferred, especially from the viewpoint of odor, harmlessness, and costs. Commercially available products of the aliphatic hydrocarbons include Isopar G, Isopar H, Isopar L, Isopar K, hereinabove manufactured by Exxon Mobile Corporation; ShellSol 71, manufactured by Shell Chemicals Japan Ltd.; IP Solvent 1620, IP Solvent 2080, hereinabove manufactured by Idemitsu Kosan Co., Ltd.; MORESCO WHITE P-55, MORESCO WHITE P-70, MORESCO WHITE P-100, MORESCO WHITE P-150, MORESCO WHITE P-260, hereinabove manufactured by MATSUMURA OIL Co., Ltd.; Cosmo White P-60, Cosmo White P-70, hereinabove manufactured by COSMO OIL LUBRICANTS, CO., LTD.: Lytol manufactured by Sonneborn; and the like. One or more members of these insulating liquids can be used in combination.

The viscosity of the insulating liquid at 25° C. is preferably 0.5 mPa·s or more, and more preferably 1 mPa·s or more, and preferably 50 mPa·s or less, more preferably 30 mPa·s or less, even more preferably 20 mPa·s or less, even more preferably 10 mPa·s or less, even more preferably 5 mPa·s or less, and even more preferably 3 mPa·s or less, from the viewpoint of improving developing ability, and from the viewpoint of improving storage stability of the toner particles in the liquid developer.

In addition, the amount of the insulating liquid used which is dropped in the step II is such that a total of the amounts of the insulating liquid used in the step I and the step II, based on 100 parts by mass of a total amount of the resin binder and the colorant, is 50 parts by mass or more, preferably 80 parts by mass or more, more preferably 100 parts by mass or more, and even more preferably 120 parts by mass or more, from the viewpoint of stability of the toner particles, and the amount used is 500 parts by mass or less, preferably 400 parts by mass or less, more preferably 300 parts by mass or less, even more preferably 240 parts by mass or less, and even more preferably 180 parts by mass or less, from the viewpoint of high solid content formation of the toner particles.

In addition, it is preferable that the amount of the insulating liquid used which is dropped in the step II is such that the solid content concentration of the liquid developer after dropping is adjusted to an amount of preferably 10% by mass or more, more preferably 15% by mass or more, and even more preferably 20% by mass or more, and preferably 50% by mass or less, more preferably 45% by mass or less, and even more preferably 40% by mass or less. After the dispersion of toner particles is obtained in the step II, the solid content concentration of the liquid developer may be adjusted by further diluting the dispersion with the insulating liquid. Here, the solid content concentration refers to a proportion of the raw materials other than the insulating liquid in the liquid developer containing the resin binder, the colorant, and the insulating liquid. The raw materials other than the insulating liquid also contain, besides the resin binder and the colorant, optionally used additives such as a releasing agent and a charge control agent.

The dropping temperature in the step II is a temperature equal to or higher than a glass transition temperature Tg of the resin binder, preferably a temperature equal to or higher than a temperature calculated as Tg plus 5° C. (+5° C.), and more preferably a temperature equal to or higher than a temperature calculated as Tg+10° C., from the viewpoint of miscibility of the raw materials for the toner particles and the insulating liquid, and the dropping temperature is preferably a temperature equal to or lower than a temperature calculated as Tg+120° C., more preferably a temperature equal to or lower than a temperature calculated as Tg+100° C., even more preferably a temperature equal to or lower than a temperature calculated as Tg+80° C., even more preferably a temperature equal to or lower than a temperature calculated as Tg+60° C., even more preferably a temperature equal to or lower than a temperature calculated as Tg+40° C., even more preferably a temperature equal to or lower than a temperature calculated as Tg+30° C., and even more preferably a temperature equal to or lower than a temperature calculated as Tg+20° C., from the viewpoint of miscibility of the raw materials for the toner particles and the insulating liquid. Here, the dropping temperature is defined as a temperature of a stirred mixture to which an insulating liquid is added dropwise.

The stirring temperature in the step I and the dropping temperature in the step II may be the same or different, wherein it is preferable that:

the stirring temperature in the step I is a temperature equal to or higher than a temperature calculated as a glass transition temperature Tg of the resin binder plus 50° C. (+50° C.), and preferably a temperature equal to or lower than a temperature calculated as Tg+150° C., more preferably a temperature equal to or lower than a temperature calculated as Tg+125° C., even more preferably a temperature equal to or lower than a temperature calculated as Tg+100° C., even more preferably a temperature equal to or lower than a temperature calculated as Tg+80° C., and even more preferably a temperature equal to or lower than a temperature calculated as Tg+70° C., and the dropping temperature in the step II is a temperature equal to or higher than a glass transition temperature Tg of the resin binder, preferably a temperature equal to or higher than a temperature calculated as Tg plus 5° C. (+5° C.), and more preferably a temperature equal to or higher than a temperature calculated as Tg+10° C., and preferably a temperature equal to or lower than a temperature calculated as Tg+40° C., more preferably a temperature equal to or lower than a temperature calculated as Tg+30° C., and even more preferably a temperature equal to or lower than a temperature calculated as Tg+20° C.

It is more preferable that the dropping of the insulating liquid in the step II is a method including dropping an insulating liquid, while further stirring the stirred mixture of the step I.

The dropping rate of the insulating liquid in the step II, per 100 g of the stirred mixture of the step I, is preferably 0.1 g/min or more, more preferably 0.5 g/min or more, even more preferably 1 g/min or more, and even more preferably 5 g/min or more, from the viewpoint of productivity, and the dropping rate is preferably 100 g/min or less, more preferably 50 g/min or less, even more preferably 30 g/min or less, even more preferably 20 g/min or less, and even more preferably 10 g/min or less, from the viewpoint of obtaining homogeneous toner particles.

The liquid developer obtainable by the method of the present invention may properly contain, in addition to the resin binder, the colorant, and the insulating liquid, an additive such as a releasing agent, a charge control agent, a charge control resin, a magnetic particulate, a fluidity improver, an electric conductivity modifier, a reinforcing filler such as a fibrous material, an antioxidant, or a cleanability improver.

The solid content concentration of the liquid developer is preferably 10% by mass or more, more preferably 15% by mass or more, and even more preferably 20% by mass or more, from the viewpoint of improving the optical density, and the solid content concentration is preferably 50% by mass or less, more preferably 45% by mass or less, and even more preferably 40% by mass or less, from the viewpoint of improving dispersion stability of the toner particles, thereby improving storage stability.

The volume-median particle size D₅₀ of the toner particles in the liquid developer is preferably 0.1 μm or more, more preferably 0.5 μm or more, and even more preferably 1 μm or more, from the viewpoint of storage stability of the liquid developer, and the volume-median particle size is preferably 30 μm or less, more preferably 20 μm or less, and even more preferably 15 μm or less, from the viewpoint of improving image quality of the liquid developer.

The content of the toner particles in the liquid developer is preferably 5% by mass or more, more preferably 10% by mass or more, and even more preferably 15% by mass or more, from the viewpoint of high-speed printing, and the content is preferably 45% by mass or less, more preferably 40% by mass or less, and even more preferably 35% by mass or less, from the viewpoint of dispersion stability of the toner particles.

The content of the insulating liquid in the liquid developer is preferably 50% by mass or more, more preferably 55% by mass or more, and even more preferably 60% by mass or more, from the viewpoint of dispersion stability of the toner particles, and the content is preferably 90% by mass or less, more preferably 85% by mass or less, and even more preferably 80% by mass or less, from the viewpoint of high-speed printing.

The viscosity at 25° C. of the liquid developer, a solid content concentration of which is 35% by mass is preferably 0.5 mPa·s or more, more preferably 1 mPa·s or more, and even more preferably 2 mPa·s or more, from the viewpoint of improving dispersion stability of the toner particles, thereby improving the storage ability, and the viscosity is preferably 50 mPa·s or less, more preferably 40 mPa·s or less, even more preferably 30 mPa·s or less, even more preferably 20 mPa·s or less, even more preferably 10 mPa·s or less, even more preferably 7.5 mPa·s or less, and even more preferably 5 mPa·s or less, from the viewpoint of improving the fusing ability of the liquid developer. Here, the viscosity of the liquid developer, a solid content concentration of which is 35% by mass as used herein means a viscosity measured by adjusting the amount of the insulating liquid to have a solid content concentration of the liquid developer of 35% by mass. The solid content concentration of the liquid developer can be adjusted by diluting with the same insulating liquid when the solid content concentration is higher than 35% by mass, or removing the insulating liquid by concentration or the like when the solid content concentration is lower than 35% by mass, respectively. Here, the solid content concentration refers to a proportion of the raw materials other than the insulating liquid in the liquid developer containing the resin binder, the colorant, and the insulating liquid. The raw materials other than the insulating liquid also contain, besides the resin binder and the colorant, optionally used additives such as a releasing agent and a charge control agent.

The present invention will be described more specifically by means of Examples, without intending to limit the present invention thereto. The physical properties of the resins and the like were measured in accordance with the following methods.

[Highest Temperature of Endothermic Peak of Acid Modified Product]

Using a differential scanning calorimeter “DSC Q20,” manufactured by TA Instruments Japan, a 0.01 to 0.02 g sample is weighed out in an aluminum pan, heated from room temperature (25° C.) to 200° C. at a heating rate of 10° C./min, and cooled from that temperature to −10° C. at a cooling rate of 5° C./min. Next, the temperature of the sample is raised to 180° C. at a heating rate of 10° C./min to measure endothermic peaks. One in which a highest temperature of endothermic peak is not detected is amorphous, and when detected, a softening point is measured in the same manner as that of the resin, and a crystallinity index (softening point/highest temperature of endothermic peak) is calculated to be judged.

[Weight-Average Molecular Weight (Mw) of Acid Modified Product of α-Olefin Polymer]

### (1) Preparation of Sample Solution

A sample is dissolved in tetrahydrofuran so as to have a concentration of 0.5 g/100 mL. Next, this solution is filtered with a fluororesin filter “FP-200,” manufactured by Sumitomo Electric Industries, Ltd., having a pore size of 2 μm, to remove insoluble components, to provide a sample solution.

### (2) Measurement of Molecular Weight Distribution

Using the following measurement apparatus and analyzing column, the measurement is taken by allowing tetrahydrofuran to flow through a column as an eluent at a flow rate of 1 mL per minute, stabilizing the column in a thermostat at 40° C., and injection a 100 μL of a sample solution thereto. The molecular weight of the sample is calculated based on the previously drawn calibration curve. At this time, a calibration curve which is drawn from several kinds of monodisperse polystyrenes, manufactured by Tosoh Corporation, A-500 (Mw 5.0×10²), A-1000 (Mw 1.01×10³), A-2500 (Mw 2.63×10³), A-5000 (Mw 5.97×10³), F-1 (Mw 1.02×10⁴), F-2 (Mw 1.81×10⁴), F-4 (Mw 3.97×10⁴), F-10 (Mw 9.64×10⁴), F-20 (Mw 1.90×10⁵), F-40 (Mw 4.27×10⁵), F-80 (Mw 7.06×10⁵), and F-128 (Mw 1.09×10⁶) as standard samples is used. The values within parentheses show molecular weights.

Measurement Apparatus: HLC-8220GPC, manufactured by Tosoh Corporation
Analyzing Column: GMHXL+G3000HXL, manufactured by Tosoh Corporation.

[Softening Point of Resin]

Using a flow tester “CFT-500D,” manufactured by Shimadzu Corporation, a 1 g sample is extruded through a nozzle having a diameter of 1 mm and a length of 1 mm with applying a load of 1.96 MPa thereto with a plunger, while heating the sample at a heating rate of 6° C./min. The softening point refers to a temperature at which half of the sample flows out, when plotting a downward movement of the plunger of the flow tester against temperature.

[Highest Temperature of Endothermic Peak of Resin]

Using a differential scanning calorimeter “Q-100,” manufactured by TA Instruments, Japan, a 0.01 to 0.02 g sample is weighed out in an aluminum pan, and cooled from room temperature (25° C.) to 0° C. at a cooling rate of 10° C./min, and kept at 0° C. for one minute. Thereafter, the temperature of the sample is raised at a heating rate of 10° C./min to take measurements. Of the endothermic peaks observed, a temperature of the peak at the highest temperature is defined as a highest temperature of endothermic peak.

[Glass Transition Temperature of Resin]

Using a differential scanning calorimeter “Q20” (manufactured by TA Instruments), a 0.01 to 0.02 g sample is weighed out in an aluminum pan, the sample is heated to 200° C., and the sample is cooled from that temperature to 0° C. at a cooling rate of 10° C./min. Next, the sample is heated at a rate of 10° C./min to take measurements of endothermic peaks. A temperature of an intersection of the extension of the baseline of equal to or lower than the highest temperature of endothermic peak and the tangential line showing the maximum inclination between the kick-off of the peak and the top of the peak in the above measurement is defined as a glass transition temperature.

[Acid Value of Resin]

The acid value is determined by a method according to JIS K0070:1992 except that only the determination solvent is changed from a mixed solvent of ethanol and ether as prescribed in JIS K0070 to a mixed solvent of acetone and toluene in a volume ratio of acetone:toluene=1:1.

[Conductivity of Insulating Liquid]

A 40 mL glass sample vial “Vial with screw cap, No. 7,” manufactured by Maruemu Corporation is charged with 25 g of an insulating liquid. The conductivity is determined by immersing an electrode in an insulating liquid, taking 20 measurements for conductivity at 25° C. with a non-aqueous conductivity meter “DT-700,” manufactured by Dispersion Technology, Inc., and calculating an average thereof. The smaller the numerical figures, the higher the resistance.

[Viscosities of Insulating Liquid and Liquid Developer]

A 10-mL glass sample vial with screw cap is charged with 6 to 7 mL of a measurement solution, and a viscosity at 25° C. is measured with a torsional oscillation type viscometer “VISCOMATE VM-10A-L,” manufactured by SEKONIC CORPORATION.

[Volume-Median Particle Size D₅₀ of Toner Particles in Liquid Developer]

A volume-median particle size D₅₀ is determined with a laser diffraction/scattering particle size measurement instrument “Mastersizer 2000,” manufactured by Malvern Instruments, Ltd., by charging a cell for measurement with Isopar L, manufactured by Exxon Mobile Corporation, isoparaffin, viscosity at 25° C.: 1 mPa·s, under conditions that a particle refractive index is 1.58, imaginary part being 0.1, and a dispersion medium refractive index is 1.42, at a concentration that gives a scattering intensity of from 5 to 15%.

Production Example 1 of Resin

A 10-liter four-neck flask equipped with a nitrogen inlet tube, a dehydration tube, a stirrer, and a thermocouple was charged with an alcohol component and terephthalic acid as listed in Table 1. The contents were heated to 235° C. An esterification catalyst and an esterification promoter as listed in Table 1 were then added thereto, and the mixture was reacted at 235° C. for 8 hours, and further reacted for one hour at 235° C. and 8.0 kPa. The reaction mixture was cooled to 160° C., and an acid modified product as listed in Table 1 was added thereto. The reaction mixture was heated to 230° C., subjected to a polycondensation reaction at 230° C. for 1 hour, and further reacted at 230° C. and 8.0 kPa until a softening point reached to a value as listed in Table 1, to provide each of amorphous polyester resins (resins A to D).

Production Example 2 of Resin

A 10-liter four-neck flask equipped with a nitrogen inlet tube, a dehydration tube, a stirrer, and a thermocouple was charged with an alcohol component and terephthalic acid as listed in Table 1. The contents were heated to 235° C. An esterification catalyst and an esterification promoter as listed in Table 1 were then added thereto, and the mixture was reacted at 235° C. for 8 hours, and then reacted at 235° C. and 8.0 kPa until a softening point reached to a value as listed in Table 1, to provide an amorphous polyester resin (resin E).

Production Example 3 of Resin

A 10-liter four-neck flask equipped with a nitrogen inlet tube, a fractional distillation tower, a dehydration tube, a stirrer, and a thermocouple was charged with an alcohol component, terephthalic acid, and PET as listed in Table 1. The contents were heated to 185° C. An esterification catalyst and an esterification promoter as listed in Table 1 were then added thereto, and the mixture was reacted at 185° C. for 5 hours, then heated stepwise to 215° C. at a rate of 5° C./h, and reacted at 215° C. for one hour. The reaction mixture was cooled to 160° C., and an acid modified product as listed in Table 1 was added thereto. The reaction mixture was then heated to 215° C., subjected to a polycondensation reaction at 215° C. for 3 hours, and further reacted at 215° C. and 40.0 kPa until a softening point reached to a value as listed in Table 1, to provide each of amorphous polyester resins (resins F and G).

TABLE 1

| | | | Resin A | Resin B | Resin C | Resin D | Resin E | Resin F | Resin G |
|---|---|---|---|---|---|---|---|---|---|
| Alcohol | BPA-PO¹⁾ | | 5740.3 | 6099.1 | 6457.8 | 5740.3 | 7224.5 | — | — |
| component | Neopentyl glycol | | — | — | — | — | — | 2298.6 | — |
| | 1,2-Propanediol | | — | — | — | — | — | — | 2316.5 |
| Carboxylic acid | Terephthalic acid | | 2259.7 | 2400.9 | 2542.2 | 2259.7 | 2775.5 | 2882.7 | 3975.5 |
| component | Acid | PIBSA1000²⁾ | 1888.5 | 1416.4 | 944.2 | — | — | 2733.6 | 1996.6 |
| | modified | PPSA1000³⁾ | — | — | — | 1888.5 | — | — | — |
| | product | | | | | | | | |

| PET | | — | — | — | — | — | 1818.7 | 2508.1 |
|---|---|---|---|---|---|---|---|---|
| Esterification | Tin(II) 2-ethylhexanoate | 40 | 42.5 | 45 | 40 | 50 | 35 | 44 |
| catalyst | | | | | | | | |
| Esterification | Gallic acid | 4.0 | 4.3 | 4.5 | 4.0 | 5.0 | — | 4.4 |
| promoter | | | | | | | | |

| | | | | | | | | |
|---|---|---|---|---|---|---|---|---|
| Physical | Softening point, ° C. | 103.0 | 104.9 | 103.3 | 104.4 | 100.7 | 97.9 | 89.2 |
| properties | Highest temperature of endothermic | 55.92 | 58.62 | 59.77 | 55.30 | 59.45 | 47.21 | 52.40 |
| of resins | peak | | | | | | | |
| | Softening point/highest temperature | 1.84 | 1.79 | 1.73 | 1.89 | 1.69 | 2.07 | 1.70 |
| | of endothermic peak | | | | | | | |
| | Glass transition temperature, ° C. | 53.85 | 56.81 | 57.68 | 53.7 | 57.2 | 45.30 | 50.32 |
| | Acid value, mgKOH/g | 2.5 | 2.7 | 3.8 | 3.8 | 7.8 | 4.0 | 11.2 |

¹⁾Polyoxypropylene(2.2)-2,2-bis(4-hydroxyphenyl)propane
²⁾PIBSA1000: an amorphous one-end modified polyisobutene succinic anhydride “H1000,” manufactured by Dover, Mw: 2400, highest temperature of endothermic peak: not detected
³⁾PPSA1000: a crystalline one-end modified polypropylene succinic anhydride “X-10065,” manufactured by Baker Hughes, Mw: 1000, softening point (94° C.)/highest temperature of endothermic peak (92° C.) = 1.02

### Examples 1 to 10 and Comparative Example 1

### [Step I]

In a 1-L four-neck flask equipped with a dehydration tube, an agitator, and a thermocouple, a resin binder, a colorant, and an insulating liquid “Isopar L” manufactured by Exxon Mobile Corporation (isoparaffin, conductivity: 6.2×10⁻¹³ S/m, viscosity at 25° C.: 1 mPa·s) as listed in Table 2 were mixed, and stirred with a paddle-shaped agitator under the conditions shown in Table 2.

The stirring conditions by the paddle-shaped agitator are as follows.

Blade: Diameter=Φ 70 mm, rotational speed=300 r/min
Here, the peripheral speed, m/s, was obtained by the following formula.

Peripheral speed (m/s)=Diameter (m)×π×Rotational Speed (r/min)/60

### [Step II]

The stirred mixture of the step I was adjusted to a dropping temperature shown in Table 2, and an insulating liquid “Isopar L” was added dropwise under the conditions shown in Table 2, while stirring under the same conditions as in the step I, to provide a dispersion of toner particles, a solid content concentration of which was 35% by mass. Thereafter, the dispersion obtained was cooled to room temperature (25° C.), to provide a liquid developer shown in Table 2.

TABLE 2

| | | | Ex. 1 | Ex. 2 | Ex. 3 | Ex. 4 | Ex. 5 | Ex. 6 |
|---|---|---|---|---|---|---|---|---|
| Step (I) | Resin | Kind | Resin A | Resin B | Resin C | Resin A | Resin A | Resin A |
| | binder | Glass transition | 53.85 | 56.81 | 57.68 | 53.85 | 53.85 | 53.85 |
| | | temperature, ° C. | | | | | | |
| | | Amount used, g | 28.5 | 28.5 | 28.5 | 28.5 | 28.5 | 28.5 |
| | Colorant | Kind | Magenta | Magenta | Magenta | Cyan | Yellow | Black |
| | | Amount used, g | 1.5 | 1.5 | 1.5 | 15 | 1.5 | 1.5 |
| | Insulating | Amount used [X1], g | 10 | 10 | 10 | 10 | 10 | 10 |
| | liquid | | | | | | | |
| | Stirring | Peripheral speed, m/s | 1.1 | 1.1 | 1.1 | 1.1 | 1.1 | 1.1 |
| | Conditions | Temperature, ° C. | 120 | 120 | 120 | 120 | 120 | 120 |
| | | Time, min | 30 | 30 | 30 | 30 | 30 | 30 |
| | Total amount of binder resin and | | 30 | 30 | 30 | 30 | 30 | 30 |
| | colorant [Y], g | | | | | | | |
| Step (II) | Insulating | Dropping amount | 45.7 | 45.7 | 45.7 | 45.7 | 45.7 | 45.7 |
| | liquid | [X2], g | | | | | | |
| | | Total amount | 55.7 | 55.7 | 55.7 | 55.7 | 55.7 | 55.7 |
| | | X1 + X2, g | | | | | | |
| | | (X1 + X2)/Y × 100 | 186 | 186 | 186 | 186 | 186 | 186 |
| | Dropping | Temperature, ° C. | 70 | 70 | 70 | 70 | 70 | 70 |
| | conditions | Rate, g/min | 3 | 3 | 3 | 3 | 3 | 3 |
| | | Rate, g/min, per | 7.5 | 7.5 | 7.5 | 7.5 | 7.5 | 7.5 |
| | | 100 g of an agitated | | | | | | |
| | | mixture | | | | | | |
| Liquid | Physical | D₅₀, μm | 9.9 | 10.1 | 27.4 | 6.7 | 7.2 | 5.8 |
| developer | properties | Viscosity, mPa · s | 4.77 | 3.39 | 1.89 | 3.64 | 3.99 | 4.14 |

| | | | | | | | Comp. |
|---|---|---|---|---|---|---|---|
| | | | Ex. 7 | Ex. 8 | Ex. 9 | Ex. 10 | Ex. 1 |
| Step (I) | Resin | Kind | Resin A | Resin D | Resin F | Resin G | Resin E |
| | binder | Glass transition | 53.85 | 53.7 | 45.30 | 50.32 | 57.2 |
| | | temperature, ° C. | | | | | |
| | | Amount used, g | 28.5 | 28.5 | 28.5 | 28.5 | 28.5 |
| | Colorant | Kind | Yellow | Magenta | Magenta | Magenta | Magenta |
| | | Amount used, g | 1.5 | 1.5 | 1.5 | 1.5 | 1.5 |
| | Insulating | Amount used [X1], g | 10 | 10 | 7.5 | 5 | 10 |
| | liquid | | | | | | |
| | Stirring | Peripheral speed, m/s | 1.1 | 1.1 | 1.1 | 1.1 | 1.1 |
| | Conditions | Temperature, ° C. | 120 | 120 | 120 | 120 | 120 |
| | | Time, min | 30 | 30 | 30 | 30 | 30 |
| | Total amount of binder resin and | | 30 | 30 | 30 | 30 | 30 |
| | colorant [Y], g | | | | | | |
| Step (II) | Insulating | Dropping amount | 45.7 | 45.7 | 48.2 | 50.7 | 45.7 |
| | liquid | [X2], g | | | | | |
| | | Total amount | 55.7 | 55.7 | 55.7 | 55.7 | 55.7 |
| | | X1 + X2, g | | | | | |
| | | (X1 + X2)/Y × 100 | 186 | 186 | 186 | 186 | 186 |
| | Dropping | Temperature, ° C. | 90 | 70 | 80 | 75 | 70 |
| | conditions | Rate, g/min | 3 | 3 | 3 | 3 | 3 |
| | | Rate, g/min, per | 7.5 | 7.5 | 8 | 8.6 | 7.5 |
| | | 100 g of an agitated | | | | | |
| | | mixture | | | | | |
| Liquid | Physical | D₅₀, μm | 12.6 | 10.7 | 17.7 | 1.03 | — |
| developer | properties | Viscosity, mPa · s | 3.74 | 5.83 | 5.21 | 4.66 | — |

Note:
Magenta: No. 7003 CARMINE6B, manufactured by Daido Chemical Corporation
Cyan: ECB-301, manufactured by DAINICHISEIKA COLOR & CHEMICALS MFG. CO., LTD.
Yellow: Paliotol Yellow D1155, manufactured by BASF
Black: Regal330R, manufactured by Cabot Corporation

It can be seen from the above results that in Examples 1 to 10, the liquid developers having smaller particle sizes of the toner particles and lowered viscosities are obtained. On the other hand, in Comparative Example 1, the phase inversion emulsification did not take place while dropping the insulating liquid, so that a liquid developer could not be obtained.

The liquid developer obtained by the method of the present invention is suitably used for development or the like of latent images formed in, for example, electrophotography, electrostatic recording method, electrostatic printing method or the like.

1: A method for producing a liquid developer comprising a resin binder, a colorant, and an insulating liquid,
the resin binder comprising a polyester resin A comprising a constituting unit derived from an alcohol component and a constituting unit derived from a carboxylic acid component comprising an acid modified product A of an α-olefin polymer having 3 or more carbon atoms and 18 or less carbon atoms, the method comprising:
I: stirring raw materials comprising the resin binder and the colorant or raw materials comprising the resin binder, the colorant, and a part of the insulating liquid at a temperature of equal to or higher than a glass transition temperature of the resin binder; and
II: adding dropwise the insulating liquid to a stirred mixture of the stirring I in an amount to make a total of the amounts used in the stirring I and the adding II of 50 parts by mass or more and 500 parts by mass or less, based on 100 parts by mass of a total amount of the resin binder and the colorant, at a temperature of equal to or higher than a glass transition temperature of the resin binder, thereby carrying out a phase inversion emulsification, to provide a dispersion of toner particles.

2: The method for producing a liquid developer according to claim 1, wherein the polyester resin A is a polyester resin comprising a structure in which a constituting unit derived from an alcohol component and a constituting unit derived from an acid modified product A of an α-olefin polymer having 3 or more carbon atoms and 18 or less carbon atoms are linked with an ester bond.

3: The method for producing a liquid developer according to claim 1, wherein the polyester resin A is a polycondensate of an alcohol component and a carboxylic acid component comprising an acid modified product A of an α-olefin polymer having 3 or more carbon atoms and 18 or less carbon atoms.

4: The method for producing a liquid developer according to claim 1, wherein the polyester resin A is a polycondensate of a polycondensate of an alcohol component and a carboxylic acid component other than an acid modified product A of an α-olefin polymer having 3 or more carbon atoms and 18 or less carbon atoms, with the acid modified product A.

5: The method for producing a liquid developer according to claim 1, wherein a dispersant is not substantially used in the adding II.

6: The method for producing a liquid developer according to claim 1, which is a method of producing a liquid developer in which the content of the dispersant is 0.5% by mass or less.

7: The method for producing a liquid developer according to claim 1, wherein the stirring temperature in the stirring I is a temperature equal to or higher than a temperature calculated as Tg plus 10° C. (+10° C.) and equal to or lower than a temperature calculated as Tg plus 125° C. (+125° C.), wherein Tg is a glass transition temperature of the resin binder.

8: The method for producing a liquid developer according to claim 1, wherein the stirring temperature in the stirring I is a temperature equal to or higher than a temperature calculated as Tg+50° C. and equal to or lower than a temperature calculated as Tg+125° C., wherein Tg is a glass transition temperature of the resin binder.

9: The method for producing a liquid developer according to claim 1, wherein the dropping temperature in the adding II is a temperature equal to or higher than a temperature calculated as Tg plus 5° C. (+5° C.) and equal to or lower than a temperature calculated as Tg plus 120° C. (+120° C.), wherein Tg is a glass transition temperature of the resin binder.

10: The method for producing a liquid developer according to claim 1, wherein the dropping temperature in the adding II is a temperature equal to or higher than a temperature calculated as Tg+5° C. and equal to or lower than a temperature calculated as Tg+40° C., wherein Tg is a glass transition temperature of the resin binder.

11: The method for production according to claim 1, wherein a weight-average molecular weight of the acid modified product A of an α-olefin polymer having 3 or more carbon atoms and 18 or less carbon atoms is 500 or more and 5,000 or less.

12: The method for production according to claim 1, wherein the acid modified product A of an α-olefin polymer having 3 or more carbon atoms and 18 or less carbon atoms is an acid modified product in which the α-olefin polymer having 3 or more carbon atoms and 18 or less carbon atoms is modified with at least one acid selected from the group consisting of maleic acid, fumaric acid, itaconic acid, and anhydrides of these acids.

13: The method for production according to claim 1, wherein the acid modified product A of an α-olefin polymer having 3 or more carbon atoms and 18 or less carbon atoms is an acid modified product in which one end of the α-olefin polymer having 3 or more carbon atoms and 18 or less carbon atoms are modified with an acid.

14: The method for production according to claim 1, wherein the α-olefin polymer having 3 or more carbon atoms and 18 or less carbon atoms is a polypropylene-based polymer, a polyisobutene-based polymer, a poly 1-butene-based polymer, a poly 1-pentene-based polymer, a poly 1-hexene-based polymer, a poly 1-octene-based polymer, a poly 4-methylpentene-based polymer, a poly 1-dodecene-based polymer, a poly 1-hexadecene-based polymer, or a propylene-hexene copolymer.

15: The method for production according to claim 1, wherein the α-olefin polymer having 3 or more carbon atoms and 18 or less carbon atoms is a polyisobutene-based polymer.

16: The method for producing a liquid developer according to claim 1, wherein the alcohol component is an alcohol component comprising an alkylene oxide adduct of bisphenol A or an aliphatic diol having 2 or more carbon atoms and 6 or less carbon atoms.
